(19) United States
(12) Patent Application Publication
(10) Pub. No.: US 2009/0318138 A1
(43) Pub. Date: Dec. 24, 2009

(54) SYSTEM AND METHOD FOR IN-FLIGHT WIRELESS COMMUNICATION

(75) Inventors: Dongsong Zeng, Germantown, MD (US); E.F. Charles LaBerge, Towson, MD (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/143,343

(22) Filed: Jun. 20, 2008

(51) Int. Cl. H04Q 7/20

(52) U.S. Cl. 455/431

(57) ABSTRACT

An aircraft radio comprises a transmitter configured to transmit wireless signals over a transmit frequency; a receiver configured to receive wireless signals over a receive frequency; and a processing unit configured to adjust the transmission frequency of the aircraft radio based on received sensor data in order to avoid interference with other wireless transmissions; wherein the processing unit is further configured to determine if a ground station is in range of the aircraft radio and to communicate directly with a second aircraft radio on another aircraft when a ground station is not in range.

### BACKGROUND

Personal wireless communication continues to grow in popularity and expand into new geographic areas as technology improves and decreases in cost. For example, the number of cell phone users continues to increase each year. Also, wireless service is available for more laptop computers through increased numbers of Wi-Fi spots and wireless adapter cards for access via cellular networks. However, one area in which personal wireless communication is prohibitively expensive or unavailable is on aircraft during flights. Wireless communication, if available, is provided through satellite communication which is expensive compared to the cost of similar non-flight service through cellular carriers. However, to avoid interference with aircraft communication, regulatory agencies, such as the Federal Aviation Administration in the United States, do not allow wireless communication via typical cellular carriers.

For the reasons stated above, and for other reasons stated below which will become apparent to those skilled in the art upon reading and understanding the present specification, there is a need in the art for an improved system and method of delivering in-flight personal wireless communication which does not interfere with aircraft communication.

### SUMMARY

The above mentioned problems and other problems are resolved by the present invention and will be understood by reading and studying the following specification.

In one embodiment, an aircraft radio is provided. The aircraft radio comprises a transmitter configured to transmit wireless signals over a transmit frequency; a receiver configured to receive wireless signals over a receive frequency; and a processing unit configured to adjust the transmission frequency of the aircraft radio based on received sensor data in order to avoid interference with other wireless transmissions; wherein the processing unit is further configured to determine if a ground station is in range of the aircraft radio and to communicate directly with a second aircraft radio on another aircraft when a ground station is not in range.

### DRAWINGS

Features of the present invention will become apparent to those skilled in the art from the following description with reference to the drawings. Understanding that the drawings depict only typical embodiments of the invention and are not therefore to be considered limiting in scope, the invention will be described with additional specificity and detail through the use of the accompanying drawings, in which:

FIG. 1A is a block diagram illustrating network topology discovery according to one embodiment of the present invention.

FIG. 1B is a block diagram illustrating network topology discovery according to another embodiment of the present invention.

FIG. 2 is a diagram illustrating a communication path from an aircraft to a ground station.

FIG. 3 is a block diagram of an aircraft communication system according to one embodiment of the present invention.

FIG. 4 is a block diagram of a block diagram of a radio according to one embodiment of the present invention.

FIG. 5 is a flow chart showing a method of providing in-flight personal wireless communication according to one embodiment of the present invention.

FIG. 6 is a flow chart showing a method of discovering network topology according to one embodiment of the present invention.

FIGS. 7A-7B are flow charts showing another method of discovering network topology according to another embodiment of the present invention.

In accordance with common practice, the various described features are not drawn to scale but are drawn to emphasize specific features relevant to the present invention. Like reference numbers and designations in the various drawings indicate like elements.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical, and electrical changes may be made without departing from the scope of the present invention. Furthermore, the method presented in the drawing figures or the specification is not to be construed as limiting the order in which the individual steps may be performed. The following detailed description is, therefore, not to be taken in a limiting sense.

Embodiments of the present invention use previously unavailable frequencies to provide sufficient bandwidth for personal wireless communication on aircraft such as video services, cell phone service, internet service, etc. In particular, embodiments of the present invention utilize the frequency range previously reserved for over-the-air analog television broadcasts. In the United States this frequency range covers channels 2-51, with each channel being 6 MHz wide, and spans the following ranges: 54-72 MHz, 76-88 MHz, 174-216 MHz, and 470-698 MHz. The Federal Communications Commission (FCC) has announced that the channels in these frequency ranges will be available for unlicensed use when analog TV broadcasts switch to digital broadcasts. Other nations have also expressed interest in allowing unlicensed use of analog television frequencies. Hence, embodiments of the present invention can also be configured to transmit in the unused TV frequencies when flying over any such nation and during transoceanic flights.

In order to use these frequencies, however, aircraft radio transmission can not interfere with the broadcasts of incumbent users of the frequency spectrum, such as TV broadcasters. Although the IEEE 802.22 working group is working on an international standard for the use of this frequency spectrum without causing interference in terrestrial applications, the standard, as outlined, is not well-suited for aircraft communications. For example, IEEE 802.22 specifies the use of a fixed point-to-multipoint network with a base station controlling frequency assignments and changes. However, aircraft are often flying where a ground base station is not available, such as during transoceanic flights.

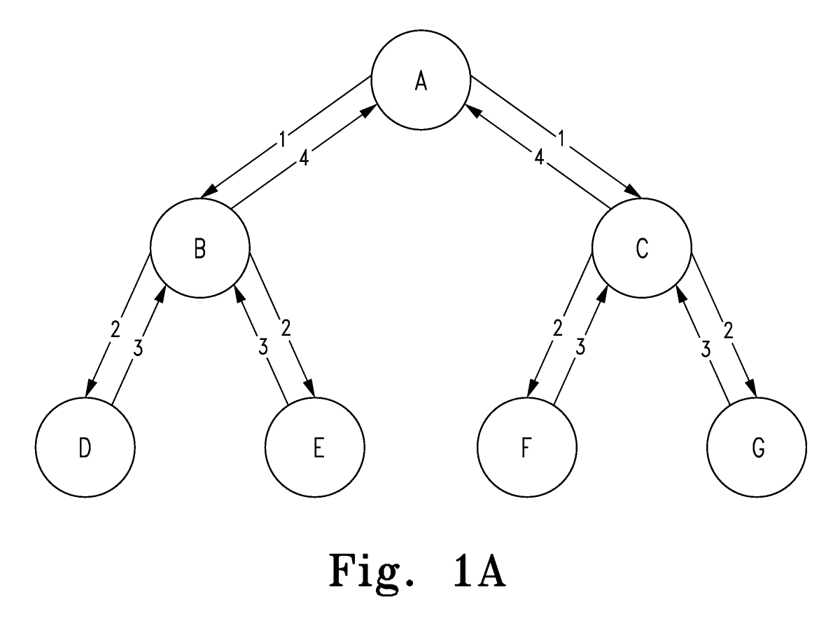

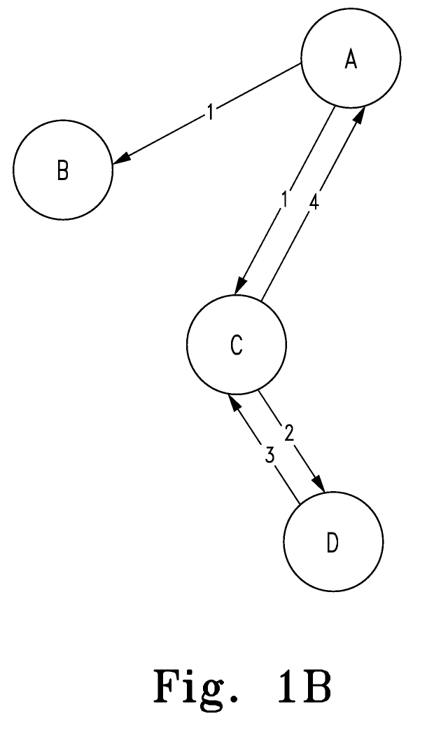

Hence, embodiments of the present invention are configured to use both a fixed point-to-multipoint network and a wireless ad hoc network. As used herein, a wireless ad hoc network is a network in which each aircraft is directly coupled to at least one other network and forwards data for other aircraft. Embodiments of the present invention automatically discover the current topology of an ad hoc or point-to-multipoint network in order to route data to its destination. For example, FIGS. 1A and 1B are block diagrams illustrating automatic topology discovery. In particular, FIG. 1A illustrates topology discovery without Automatic Dependent Surveillance-Broadcast (ADS-B) information.

In FIG. 1A, node A broadcasts a discovery message (indicated by arrows 1) which includes information specific to node A, such as node A's identification (ID) number, speed, and position. Each node which is in range of node A's discovery message forwards the discovery message to other nodes. Hence, nodes B and C forward the discovery message to nodes D, E, F, and G as indicated by arrows 2. Each of nodes D, E, F, and G can also forward the discovery message to additional nodes not shown until a ground station is reached.

Once a ground station is reached, nodes D and E respond to node B while nodes F and G respond to node C. Node B aggregates the responses from nodes D and E with its own response and sends the aggregated response to node A. Similarly, node C aggregates the responses from nodes F and G and sends the aggregated response to node A. Node A then analyzes the results to discover the topology of the ad hoc network. Based on the discovered topology, node A is able to determine a route from node A to a ground station. Since the network topology changes frequently, node A updates the topology discovery periodically by repeating the above process.

Alternatively, FIG. 1B illustrates ADS-B aided topology discovery according to one embodiment of the present invention. In FIG. 1B, node A broadcasts a discovery message (indicated by arrows 1) which includes information specific to node A, such as node A's identification (ID) number, speed, and position. In addition, the broadcast message includes data regarding node B obtained from ADS-B signals. Based on the ADS-B data, node C has long distance priority to forward node A's message first. In other words, since Node C is located further away in the direction of message propagation, node C has priority over node B. Node C then forwards the discovery message (indicated by arrow 2) to node D. Node B also hears the message forwarded from node C. Node B recognizes the priority of node C and, therefore, does not forward or respond to node A's discovery message.

Node D receives the forwarded discovery message and forwards it to additional nodes not shown until a ground station is reached. Once a ground station is reached, node D responds to node C (indicated by arrow 3). Node C aggregates the response from node D with its own response and sends the aggregated response to node A (indicated by arrow 4). Node A then analyzes the results to discover the topology of the ad hoc network. Based on the discovered topology, node A is able to determine a route from node A to a ground station. Since the network topology changes frequently, node A updates the topology discovery periodically by repeating the above process.

Nodes A-F in FIGS. 1A and 1B each represent aircraft during flight. It is to be understood that embodiments of the present invention are not to be limited to the number of nodes shown in FIGS. 1A and 1B. In addition, multiple paths from node A to a ground station can be discovered with the discovery messages. In such situations, node A selects the best route based on data traffic, transmission distance, etc. One method of selecting a transmission path, which can be implemented in embodiments of the present invention, is described in co-pending U.S. patent application Ser. No. 11/561,977 (attorney docket no. H0012841-5602) which is incorporated herein by reference (the '977 application).

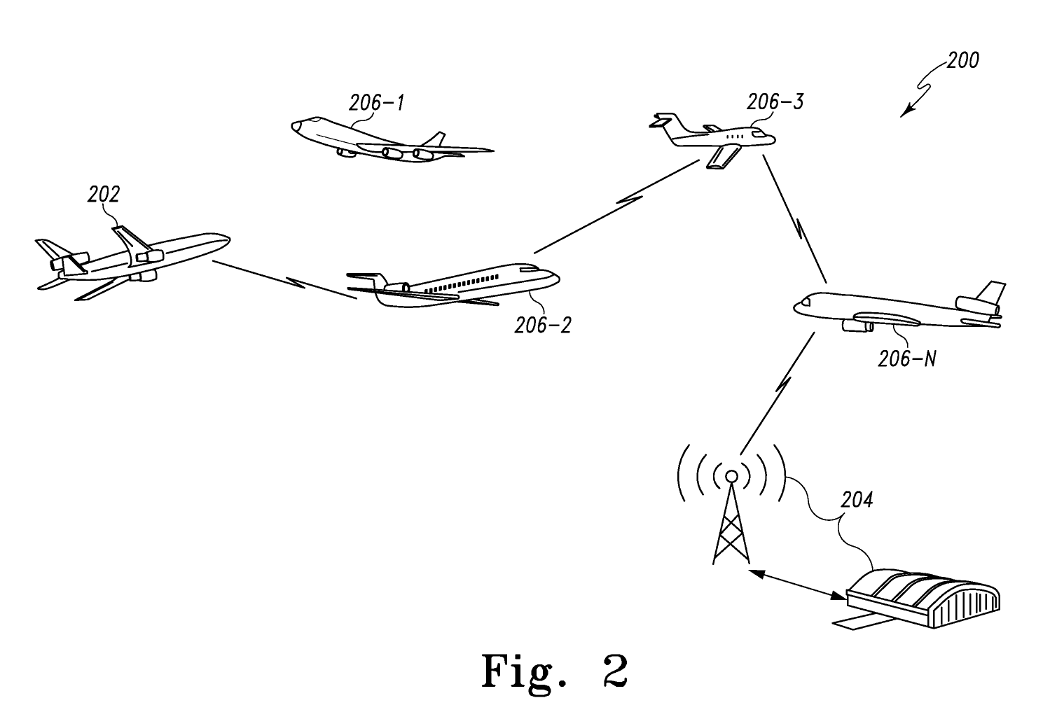

FIG. 2 is diagram illustrating a communication path from an aircraft to a ground station after discovering the topology as discussed above. As shown in FIG. 2, aircraft 202 is not in range of ground station 204. Hence, aircraft 206-2 . . . 206-N relay the data from aircraft 202 to ground station 204. Thus, unlike in IEEE 802.22, each aircraft cognitive radio is capable of communicating directly with another aircraft radio using detect and avoid techniques to switch frequencies and avoid interference.

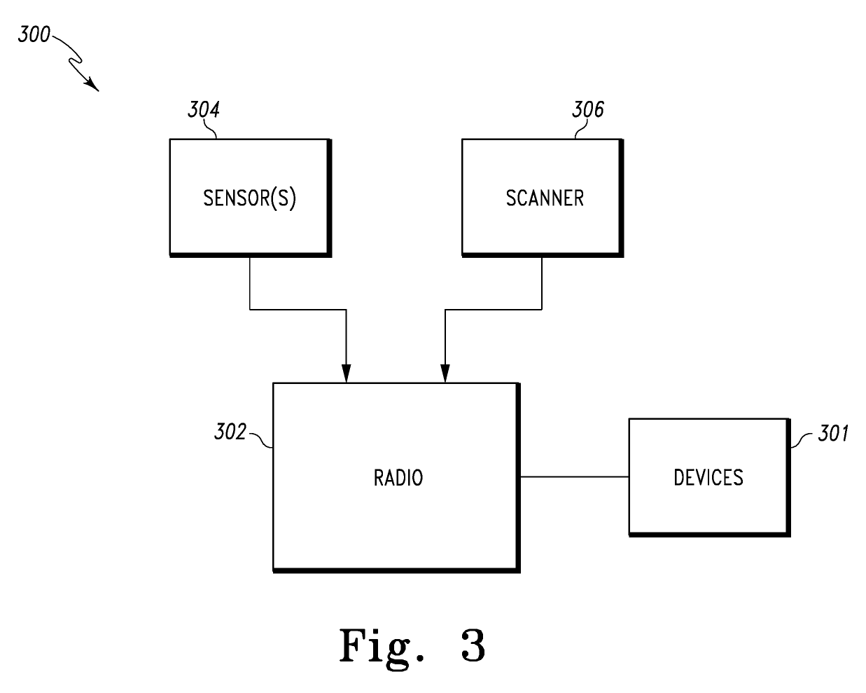

FIG. 3 is a block diagram of an aircraft communication system 300 according to one embodiment of the present invention. System 300 includes a radio 302, one or more sensors 304 and a scanner 306. Sensors 304 are configured to provide data regarding the environment surrounding the aircraft. For example, sensors 304 can include, but are not limited to, a global positioning system (GPS) receiver for determining the location of the aircraft, an accelerometer for determining the speed of the aircraft, and an altimeter for determining the altitude of the aircraft. Scanner 306 is configured to perform distributed measurement of the analog TV radio frequencies using techniques known to one of skill in the art.

Radio 302 uses the data received from sensors 304 and scanner 306 to adjust the power, frequency, modulation scheme, and/or other parameters to avoid interference with other transmissions and use the available spectrum. Additionally, radio 302 is configured to avoid interfering with communication on-board the aircraft. For example, in some embodiments, techniques described in co-pending U.S. patent application Ser. No. ______ (attorney docket no. H0018694), incorporated herein by reference, are used to avoid interference with both on-board communication and other transmissions to/from the aircraft. Radio 302 then transmits data received from devices 301 on-board the aircraft using the selected frequencies from the analog TV spectrum. Devices 301 can include, but are not limited to, cell phones, laptop computers, personal digital assistants, etc. In addition, devices 301 can be connected wirelessly or via a wired connection to radio 301. Alternatively, devices 301 can be connected to a separate processing unit which processes the data and provides the data to radio 302.

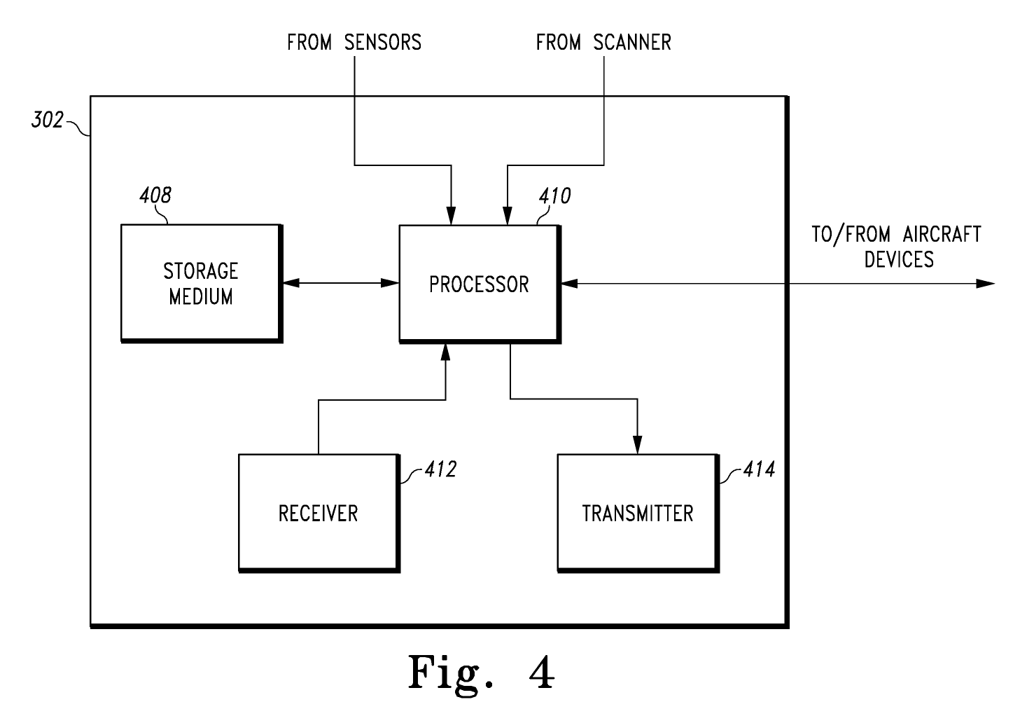

FIG. 4 is a block diagram of radio 302 according to one embodiment of the present invention. Radio 302 includes a processor 410 which receives the data from sensors 304 and scanner 306. Processor 410 analyzes the data to determine which frequencies are available and/or if a change in transmission frequency is needed. Once a frequency is chosen for transmission, processor 410 formats data from devices on the aircraft and provides the formatted data to the transmitter 414 to transmit over the selected frequency. For example, if the data indicates that the aircraft is currently flying over an ocean, transmission power can be increased to greater levels than when flying over a country. In addition, processor 410 can adjust the frequencies to be scanned based on the country over which it is flying to adhere to different laws and available frequencies in each nation.

Processor 410 also causes discovery messages to be transmitted over a selected frequency or set of frequencies, to discover the topology as discussed above. In particular, processor 410 determines if an ad hoc network connection or a fixed point-to-multipoint network connection is being used. For example, if processor 410 determines that a ground station is not in range, processor 410 is configured to process and transmit data for an ad hoc network connection. However, if processor 410 determines that a ground station is in range, processor 410 switches to a point-to-multipoint connection in which the ground station is responsible for directing processor 410 to switch frequencies when necessary.

Processor 410 includes or functions with software programs, firmware or computer readable instructions for carrying out various methods, process tasks, calculations, and control functions, used in calculating the desired speeds for an autonomous vehicle. These instructions are typically tangibly embodied on any appropriate medium used for storage of computer readable instructions or data structures. Such computer readable media can be any available media that can be accessed by a general purpose or special purpose computer or processor, or any programmable logic device. Suitable computer readable media may include storage or memory media such as magnetic or optical media, e.g., disk or CD-ROM, volatile or non-volatile media such as RAM (e.g. SDRAM, DDR SDRAM, RDRAM, SRAM, etc.), ROM, EEPROM, flash memory, etc. as well as transmission media such as electrical, electromagnetic, or digital signals, conveyed via a communication medium such as a network and/or a wireless link. In this embodiment, the instructions are stored on storage medium 408.

When radio 302 receives a broadcast from another aircraft radio, processor 410 determines if the data is addressed to a device on the aircraft. If it is, processor 410 processes the data and provides it to the device. If not, processor 410 forwards the data over a selected frequency to one or more other aircraft. Processor 410 selects the frequency or set of frequencies independently of the frequency on which it was received. In this way, each aircraft radio in a transmission path of an ad hoc network is responsible for determining the frequency to use for forwarding and transmitting data in order to avoid interference. In some embodiments, one set of frequencies is selected for forwarding data and another is selected for transmission of data from devices on the aircraft. In other embodiments, the same set of frequencies are used.

Hence, unlike the standard defined by IEEE 802.22, each aircraft's radio is configured to make decisions regarding transmission power, transmission frequency, etc. and to make necessary changes. In addition, each aircraft's radio is configured to adjust modes when a ground station is in range to allow the ground station to control channel assignment, power levels, etc. similar to a wireless device under control of a base station in the IEEE 802.22 standard. In one embodiment, the radio determines if a ground station is in range by submitting a discovery message and detecting if a ground station responds.

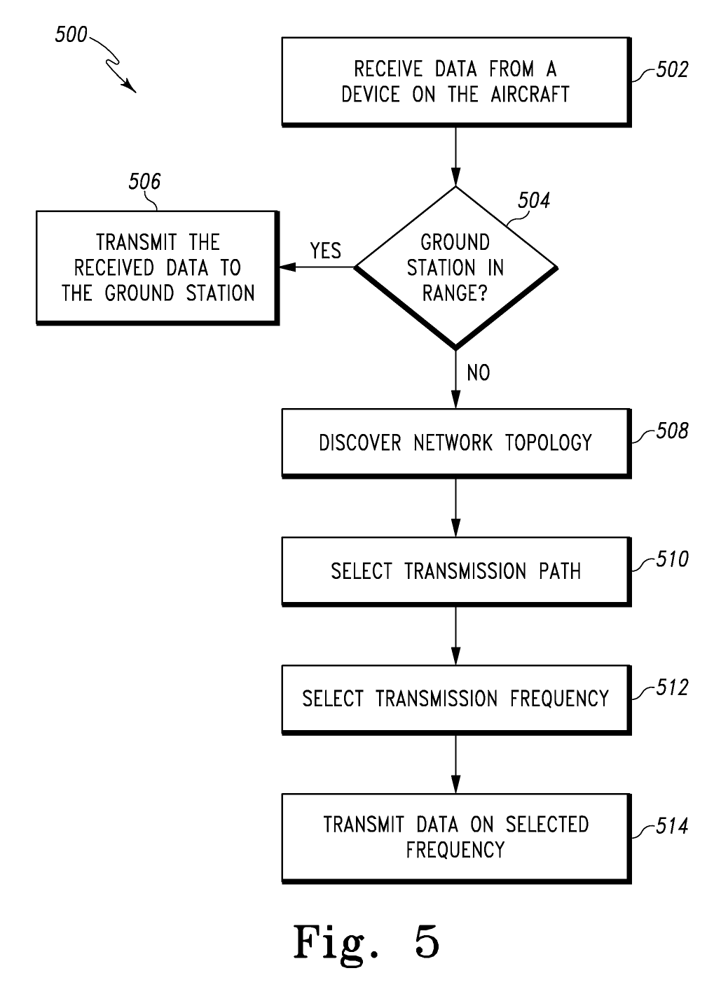

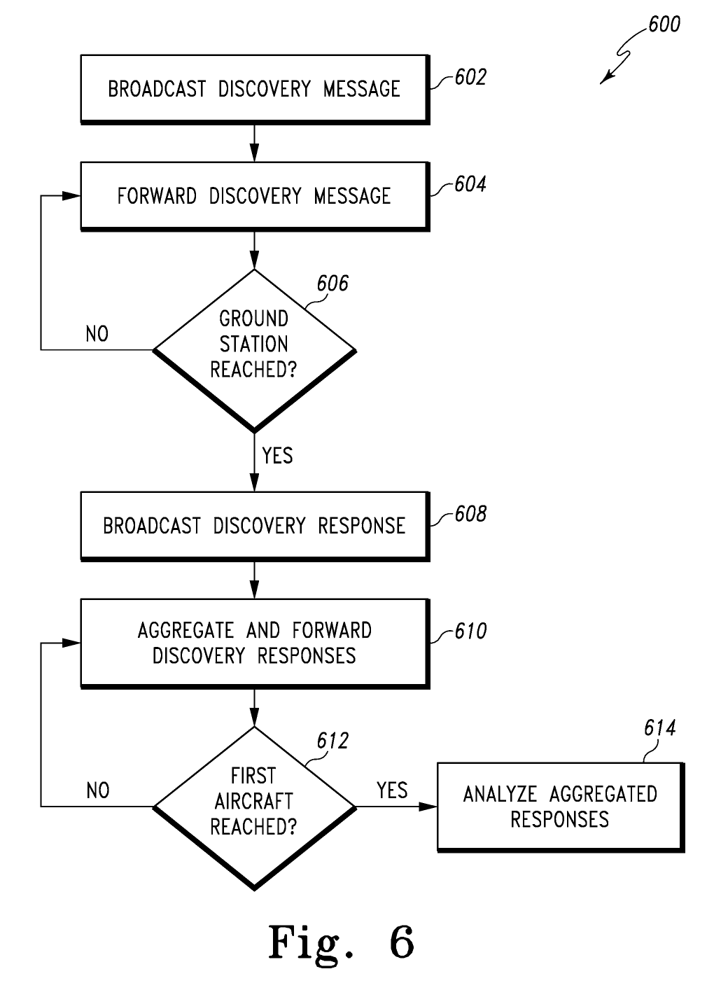

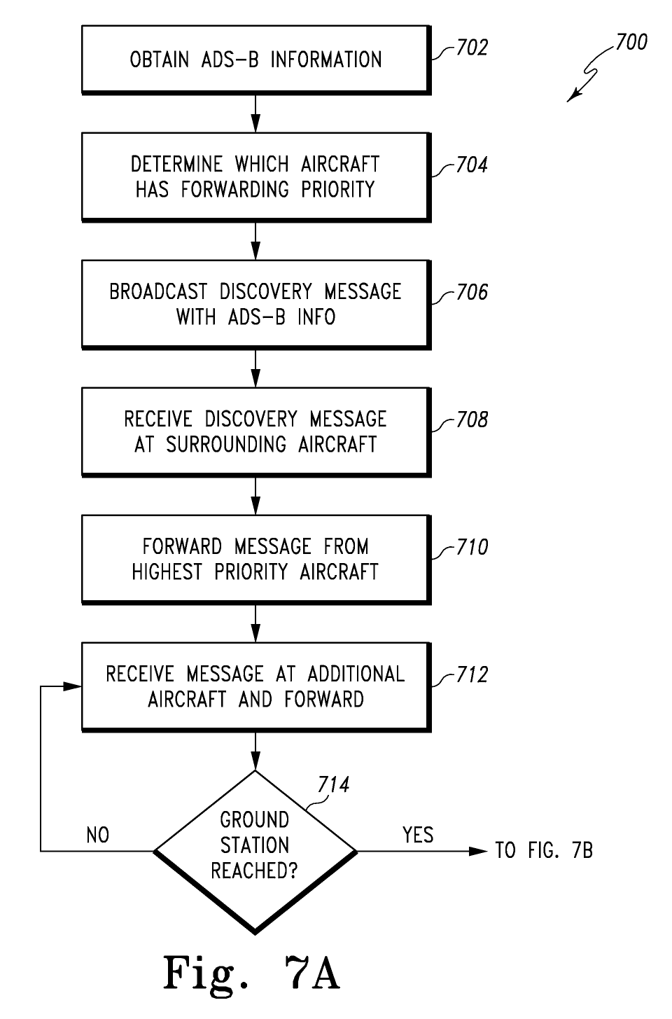

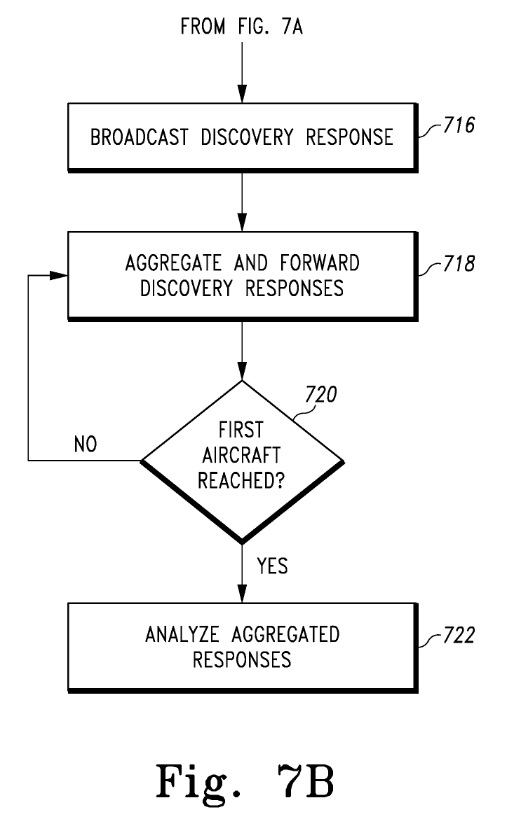

FIG. 5 is a flow chart showing a method 500 of providing in-flight personal wireless communication according to one embodiment of the present invention. Method 500 can be implemented in a system such as system 300 above. At 502, the aircraft radio receives data from a device on the aircraft. For example, the aircraft radio can receive data from a laptop computer, cell phone, personal digital assistant, etc. At 504, it is determined if a ground station is in range of the aircraft radio. If a ground station is in range, the aircraft radio transmits the received data to the ground station over a frequency assigned by the ground station at 506. If a ground station is not in range, a network topology is discovered by the aircraft radio at 508. Exemplary methods of discovering topology are described below in more detail with respect to FIGS. 6 and 7.

At 510, the aircraft radio selects a route for data to be sent from the aircraft to a ground station. In particular, the aircraft radio transmits with the data information identifying the aircraft that are to forward the data. Hence, an aircraft which hears the data but is not identified as a forwarding aircraft can simply drop the data. In some embodiments, the aircraft radio selects the route based on the location of the aircraft discovered during topology discovery. In other embodiments, the aircraft are selected based on airline agreements. Exemplary methods of selecting the route are further described in the '977 application.

At 512, the aircraft radio selects the frequency or set of frequencies on which to transmit the data. In particular, the aircraft radio performs detect and avoid techniques as known to one of skill in the art. At 514, the aircraft radio transmits the data on the selected frequency. In particular, the frequency selected is in the range of analog TV frequencies as described above.

FIG. 6 is a flow chart showing a method 600 of discovering topology according to one embodiment of the present invention. At 602, an aircraft broadcasts a discovery message containing information identifying the aircraft, such as the aircraft's ID number, speed, and position. At 604, each receiving aircraft which receives the broadcast discovery message forwards the message to additional receiving aircraft. Each additional receiving aircraft continues to forward the discovery message until, at 606, it is determined that a ground station has received the discovery message. The ground station broadcasts a discovery response, at 608, which each additional receiving aircraft in range receives. The discovery message contains information identifying the ground station. Each additional receiving aircraft in range of the ground station aggregates the ground station information with information identifying itself and forwards the aggregated response at 610. Each receiving aircraft continues to aggregate and forward the response until all the aggregated responses are received by the first aircraft which originated the discovery message at 612. The first aircraft then analyzes the response to determine the topology of the network at 614.

FIG. 7 is a flow chart showing another method 700 of discovering topology according to one embodiment of the present invention. At 702, a first aircraft obtains ADS-B information from surrounding aircraft. At 704, the first aircraft determines which of the surrounding aircraft has priority for forwarding a discovery message based on the ADS-B information. In some embodiments, it is determined which aircraft has the highest priority based on the location of the surrounding aircraft in relation to a target ground station. In other words, the surrounding aircraft that is closest to the target destination has priority. In other embodiments, an aircraft of the same airline may have priority over aircraft of other airlines. That is, the determination is based on airline agreements for forwarding of data. At 706, the first aircraft broadcasts the discovery message containing information identifying the first aircraft. In addition, the discovery message contains ADS-B information of the surrounding aircraft and an indication of which aircraft has priority. At 708, the surrounding aircraft in range of the first aircraft receive the discovery message.

At 710, the surrounding aircraft with highest priority forwards the discovery message. The other surrounding aircraft, which hear the forwarded message, do not forward the discovery message. If the other surrounding aircraft do not hear the forwarded message, the next highest priority aircraft forwards the discovery message. Additional aircraft in range of the priority aircraft forward the received discovery message at 712. The discovery message is forwarded again until, at 714, it is determined that a ground station has received the discovery message. The ground station broadcasts a discovery response, at 716, which each additional receiving aircraft in range receives. The discovery message contains information identifying the ground station. Each additional receiving aircraft in range of the ground station aggregates the ground station information with information identifying itself and forwards the aggregated response at 718. Each receiving aircraft continues to aggregate and forward the response until all the aggregated responses are received by the first aircraft, at 720, which originated the discovery message. The first aircraft then analyzes the response to determine the topology of the network at 722.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An aircraft radio comprising:
a transmitter configured to transmit wireless signals over a transmit frequency;
a receiver configured to receive wireless signals over a receive frequency; and
a processing unit configured to adjust the transmission frequency of the aircraft radio based on received sensor data in order to avoid interference with other wireless transmissions;
wherein the processing unit is further configured to determine if a ground station is in range of the aircraft radio and to communicate directly with a second aircraft radio on another aircraft when a ground station is not in range.

2. The aircraft radio of claim 1, wherein the transmit frequency and the receive frequency are in the spectrum assigned to analog television broadcasts.

3. The aircraft radio of claim 1, wherein the analog television broadcast spectrum comprises the frequency ranges of 54-72 MHz, 76-88 MHz, 174-216 MHz, and 470-698 MHz.

4. The aircraft radio of claim 1, wherein the processing unit is further configured to adjust at least one of the transmission power and modulation scheme based on the received sensor data.

5. The aircraft radio of claim 1, wherein the processing unit is further configured to provide the received sensor data to a ground station when in range, and to adjust the transmit frequency based on commands received from the ground station.

6. The aircraft radio of claim 1, wherein the processing unit is configured to discover network topology when not in range of a ground station.

7. An aircraft communication system comprising:
at least one sensor configured to provide data regarding the environment surrounding the aircraft communication system;
a scanner configured to perform distributed measurement of a set frequency spectrum;
a radio coupled to the at least one sensor and the scanner, the radio configured to adjust the transmission frequency of the radio based on data received from the at least one sensor and the scanner in order to avoid interference with other wireless transmissions;
wherein the radio is further configured to determine if a ground station is in range and to communicate directly with a second aircraft's radio when a ground station is not in range.

8. The aircraft communication system of claim 7, wherein the scanner is configured to perform distributed measurement of a frequency spectrum assigned to analog television broadcasts.

9. The aircraft communication system of claim 8, wherein the frequency spectrum includes the frequency ranges of 54-72 MHz, 76-88 MHz, 174-216 MHz, and 470-698 MHz.

10. The aircraft communication system of claim 7, wherein the at least one sensor includes one or more of an altimeter, a global positioning system (GPS) receiver, an Automatic Dependent Surveillance-Broadcast (ADS-B) receiver, and an accelerometer.

11. The aircraft communication system of claim 7, wherein the radio is further configured to provide the received sensor data to a ground station when in range, and to adjust the transmit frequency based on commands received from the ground station.

12. The aircraft communication system of claim 7, wherein the radio is configured to discover network topology when not in range of a ground station.

13. The aircraft communication system of claim 12, wherein the radio is further configured to select a transmission path from the aircraft to a ground station based on the discovered network topology.

14. The aircraft communication system of claim 7, wherein the radio is configured to forward wireless communication signals received from other aircraft.

15. A method of providing in-flight personal wireless communication on a first aircraft, the method comprising:
receiving data from a device on the first aircraft;
determining if a ground station is in range;
when a ground station is in range, transmitting the received data to the ground station over a frequency assigned by the ground station; and
when a ground station is not in range,
discovering network topology;
selecting a transmission path;
selecting a transmission frequency to avoid interference with other wireless transmissions; and
transmitting the data on the selected transmission frequency.

16. The method of claim 15, wherein selecting a transmission frequency comprises selecting a transmission frequency from a frequency spectrum assigned to analog television broadcasts.

17. The method of claim 16, wherein selecting a transmission frequency comprises selecting a transmission frequency from the frequency ranges of 54-72 MHz, 76-88 MHz, 174-216 MHz, and 470-698 MHz.

18. The method of claim 15, wherein discovering network topology comprises:
broadcasting a discovery message from the first aircraft;
forwarding the broadcast message via additional aircraft until a ground station is reached;
broadcasting a discovery response from the ground station; and
forwarding the discovery response aggregated with information regarding each additional aircraft which forwards the discovery response until the first aircraft is reached;
analyzing the aggregated discovery responses to identify the additional aircraft between the first aircraft and the ground station.

19. The method of claim 15, wherein discovering network topology comprises:
obtaining automatic dependent surveillance-broadcast (ADS-B) information regarding aircraft surrounding the first aircraft;
determining which surrounding aircraft has priority to forward a discovery message from the first aircraft;
broadcasting the discovery message with the ADS-B information and an indication of which surrounding aircraft has priority to forward the discovery message;
forwarding the discovery message only from the surrounding aircraft with the highest priority;
receiving the forwarded message at additional aircraft within range of the surrounding aircraft with the highest priority;
forwarding the discovery message from the additional aircraft until a ground station is reached;
broadcasting a discovery response from the ground station;
forwarding the discovery response aggregated with information regarding each additional aircraft which forwards the discovery response until the first aircraft is reached; and
analyzing the aggregated discovery responses to identify the additional aircraft between the first aircraft and the ground station.

20. The method of claim 19, wherein determining which surrounding aircraft has the highest priority comprises at least one of:
determining which surrounding aircraft is located closest to a target ground station; and
determining which surrounding aircraft has priority based on airline agreements.
